(19) United States
(12) Patent Application Publication
(10) Pub. No.: US 2025/0299674 A1
(43) Pub. Date: Sep. 25, 2025

(54) AI-Based Legal Counsel System and Method of Use

(71) Applicant: Adam Denoto, Brook Park, OH (US)

(72) Inventor: Adam Denoto, Brook Park, OH (US)

(21) Appl. No.: 18/950,317

(22) Filed: Nov. 18, 2024

Related U.S. Application Data
(60) Provisional application No. 63/566,979, filed on Mar. 19, 2024.

(51) Int. Cl. G10L 15/22; G06F 16/248; G06F 21/62; G06Q 50/18

(52) U.S. Cl. CPC G10L 15/22; G06F 16/248; G06F 21/6245; G06Q 50/18; G10L 2015/223

(57) ABSTRACT

The present invention relates to an AI-based legal counsel system designed to assist users during law enforcement encounters. The system utilizes a mobile application and a server system to provide real-time legal advice. The server system includes a natural language processing module for interpreting voice commands, an AI module that generates legal counsel based on a comprehensive legal database, and a user profile database for personalized assistance. The system also features cloud storage for securely recording and storing police interactions. Additionally, the mobile application allows users to request in-person legal assistance by matching them with available lawyers based on location and expertise. The application includes emergency features like an SOS button and live streaming to ensure user safety during critical situations.

### CROSS-REFERENCE TO RELATED APPLICATION

The present application claims priority to, and the benefit of, U.S. Provisional Application No. 63/566,979, which was filed on Mar. 19, 2024, and is incorporated herein by reference in its entirety.

### FIELD OF THE INVENTION

The present invention generally relates to the field of legal technology and real-time legal assistance systems. More specifically, the present invention relates to an AI-based legal counsel system designed to provide immediate legal support during law enforcement encounters. The system includes a mobile application that interacts with a server system housing an AI module, a legal database, and cloud storage for recording police interactions. The AI module processes voice commands from the user, offering real-time legal advice, while the system can also connect users with live legal representation when needed. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, when individuals are arrested by law enforcement, individuals need immediate access to legal representation to ensure their rights are protected. However, in many situations, particularly during late-night interrogations or unexpected encounters, individuals may find it difficult or even impossible to contact their lawyer. Under such circumstances, they may be subjected to questioning without legal counsel, often leading to confusion and the possibility of coerced or uninformed responses.

The absence of timely legal representation can have severe consequences. Individuals may inadvertently provide information that could be used against them, or they may waive certain legal rights without fully understanding the implications. The lack of representation and support can lead to wrongful imprisonment or other legal injustices, with little to no accountability for law enforcement officers who may act improperly.

Moreover, existing legal systems often lack the infrastructure to provide immediate, on-demand legal assistance, leaving many individuals vulnerable during critical moments of law enforcement encounters. People desire a solution that provides quick access to legal representation, regardless of the time or circumstances.

Therefore, there exists a long-felt need in the art for a system that can provide immediate and reliable legal counsel during law enforcement encounters. There is also a long-felt need in the art for a solution that can protect individuals' legal rights by offering real-time and AI-based legal advice. Additionally, there is a long-felt need in the art for a system that ensures the preservation of evidence through secure recording of police encounters. Moreover, there is a long-felt need in the art for a system that can seamlessly connect users with live legal representation when necessary, ensuring that individuals have access to qualified lawyers regardless of the time or location. Furthermore, there is a long-felt need in the art for a user-friendly, mobile-based application that provides a comprehensive and accessible legal defense tool. Finally, there is a long-felt need in the art for an innovative approach to legal defense systems that leverages artificial intelligence to deliver prompt, effective, and personalized legal assistance during law enforcement interactions.

The subject matter disclosed and claimed herein, in one embodiment thereof, comprises an AI-based legal counsel system designed to provide immediate legal support during law enforcement encounters. The system includes a mobile application that interacts with a server system that includes various modules critical for real-time legal assistance. The mobile application is capable of receiving and processing voice commands, which are converted into actionable legal advice by the AI module using data from a continuously updated legal database. Additionally, the system features a secure cloud storage module that records and stores interactions with law enforcement, providing a reliable and tamper-proof record of events. The system also offers a feature that allows users to request in-person legal assistance, which then matches them with available lawyers based on their location and specific needs.

In this manner, the AI-based legal counsel system of the present invention accomplishes all of the foregoing objectives and provides a solution for providing legal protection during police encounters. The system delivers precise and context-specific legal advice on demand using an AI-engine, thereby significantly reducing the risk of individuals being coerced or making uninformed decisions under duress. The system's ability to securely record and store interactions with law enforcement further enhances the user's legal standing, offering a critical safeguard against potential abuses of power or wrongful imprisonment. Additionally, the seamless integration of a live lawyer matching service ensures that users have access to professional legal representation when it matters most, regardless of the time or circumstances.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a system for providing AI-based legal counsel and defense during law enforcement encounters. The system comprises a mobile application configured to receive voice commands from a user, the mobile application being installed on an electronic computing device. A server system is in communication with the mobile application via a communication network, the server system includes a natural language processing (NLP) module adapted to convert the received voice commands into text or commands, an AI module configured to generate legal advice based on the commands using data from a legal database, a user profile database for storing user-specific data, including personal information and legal history, and a cloud storage module for securely storing user data, including recordings of police encounters.

In yet another embodiment, a system for providing real-time legal assistance during police encounters is disclosed. The system includes a mobile application functioning as a client and installed on a user's mobile device, the mobile application is configured to interface with a server system. The server system comprises a legal database storing updated legal information, statutes, and case law, an authentication module adapted to verify user identities and manage access to legal services, a billing module configured to manage user subscriptions and payment processing, and an AI module configured to generate legal advice based on the commands using data from a legal database.

In another embodiment, a method for providing AI-based legal counsel to a user during a law enforcement encounter is disclosed. The method comprises the steps of receiving a voice request from the user through a mobile application installed on an electronic device, converting the received voice request into text using a natural language processing (NLP) module, querying a legal database to retrieve relevant legal information based on the converted text, and generating and presenting legal advice to the user in real-time through the mobile application.

In still another embodiment, a method for providing in-person legal assistance to a user during a police encounter is described. The method comprises the steps of receiving a request for live legal assistance from the user through a mobile application, matching the user with available lawyers in the user's area based on location, availability, and expertise, providing real-time updates to the user regarding the lawyer's status, including estimated time of arrival or connection progress, and transmitting relevant information about the user and the encounter to the selected lawyer to facilitate informed legal support.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of the AI-based legal counsel system of the present invention in accordance with the disclosed architecture;

FIG. 2 illustrates an exemplary user interface displayed by the justified mobile application in accordance with the disclosed structure;

FIG. 3 illustrates an exemplary user interface for providing legal assistance to a user by the application in accordance with the disclosed architecture;

FIG. 4 illustrates another exemplary interface displayed by the legal counsel mobile application of the present invention for providing legal assistance to a user in accordance with one embodiment of the present invention;

FIG. 5 illustrates a user interface displayed by the mobile application for providing AI-based legal counsel to a user in accordance with the disclosed structure;

FIG. 6 illustrates a user interface for providing emergency services to a user by the system 100 in accordance with the disclosed structure;

FIG. 7 illustrates a flow chart depicting a process of providing AI-based legal counsel to a user in accordance with one embodiment of the present invention; and

FIG. 8 illustrates another flow diagram showing a process for providing in-person legal help to a user in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a system that can provide immediate and reliable legal counsel during law enforcement encounters. There is also a long-felt need in the art for a solution that can protect individuals' legal rights by offering real-time and AI-based legal advice. Additionally, there is a long-felt need in the art for a system that ensures the preservation of evidence through secure recording of police encounters. Moreover, there is a long-felt need in the art for a system that can seamlessly connect users with live legal representation when necessary, ensuring that individuals have access to qualified lawyers regardless of the time or location. Furthermore, there is a long-felt need in the art for a user-friendly, mobile-based application that provides a comprehensive and accessible legal defense tool. Finally, there is a long-felt need in the art for an innovative approach to legal defense systems that leverages artificial intelligence to deliver prompt, effective, and personalized legal assistance during law enforcement interactions.

The present invention, in one exemplary embodiment, is a system for providing AI-based legal counsel and defense during law enforcement encounters. The system comprises a mobile application configured to receive voice commands from a user, the mobile application being installed on an electronic computing device. A server system is in communication with the mobile application via a communication network, the server system includes a natural language processing (NLP) module adapted to convert the received voice commands into text or commands, an AI module configured to generate legal advice based on the commands using data from a legal database, a user profile database for storing user-specific data, including personal information and legal history, and a cloud storage module for securely storing user data, including recordings of police encounters.

Reference will now be made in detail to the present preferred embodiments of the invention, examples of which are illustrated in the accompanying drawings. Wherever possible, the same reference numerals are used in the drawings and the description to refer to the same or like parts.

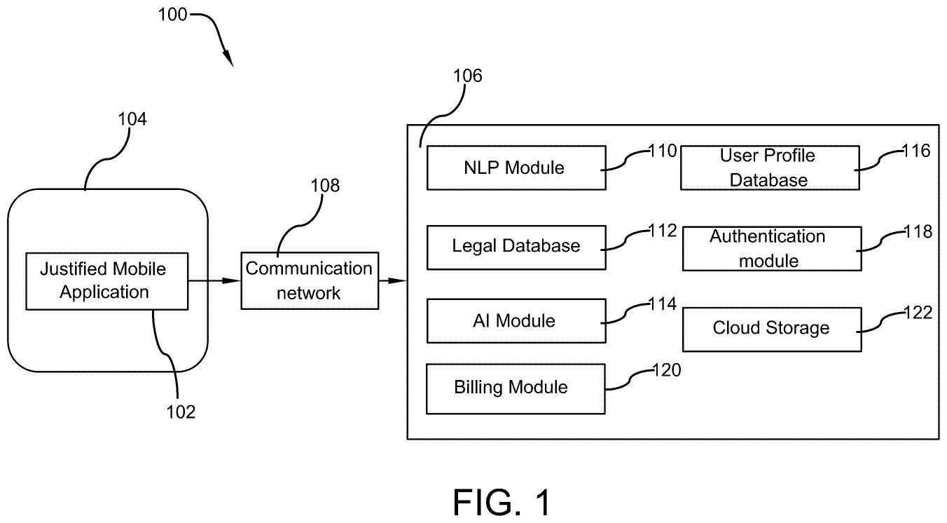

Referring initially to the drawings, FIG. 1 illustrates a schematic view of the AI-based legal counsel system 100 of the present invention in accordance with the disclosed architecture. The AI-based legal counsel system 100 of the present invention is designed as a client-server architecture to assist users during encounters with law enforcement. The system 100 provides legal counsel and defense in real-time through the use of artificial intelligence (AI) and also offers features to ensure the user's safety and legal rights are protected during interactions with the police.

More specifically, the system 100 includes an AI-based legal counsel mobile application 102 which acts as the client and is adapted to communicate with a server system 106 via a communication network 108. The AI-based legal counsel application 102 is configured to be installed and operated using an electronic computing device 104 such as but not limited to a mobile phone. The application 102 provides local processing of the requests from a user and the server system 106 includes a plurality of modules for providing quick, secure, and effective legal support during police encounters.

The server 106 includes a natural language processing (NLP) module 110 which is adapted to receive voice commands from the application 102 and processes the received voice commands. The module 110 converts spoken language into text or commands interpretable by the AI module 114 of the system 100. The system 100 is comprised of a legal database 112 with a regularly updated (ex. every week) updated repository of legal information, statutes, and case law used by the AI module 114 to provide accurate legal advice to the user. The legal database 112 is preferably updated in real-time by the system 100.

The AI module 114 is adapted to train from past interactions and outcomes of different users with the system 100. The AI module 114 is trained on the data stored in the legal database 112. A user profile database 116 is adapted to store user-specific data including a user's personal information, legal history, and preferences. An authentication module 118 authorizes users and their subscription to the system 100 using the information stored in the user profile database 116. The module 118 ensures that only authorized users can access sensitive data or initiate legal assistance using the system 100.

A billing module 120 is adapted to manage the subscription services of users, ensuring users are billed appropriately based on their usage of the system 100. In some embodiments, a user can be charged based on per request or query basis and the application 102 can provide wallet services for billing. The system 100 is adapted to store all the user information, legal advice, recordings of police encounters and other user data in a secure and encrypted cloud storage 122. The cloud storage 122 can be a distributed cloud storage and additional storage space can be subscribed to by users by paying additional pricing.

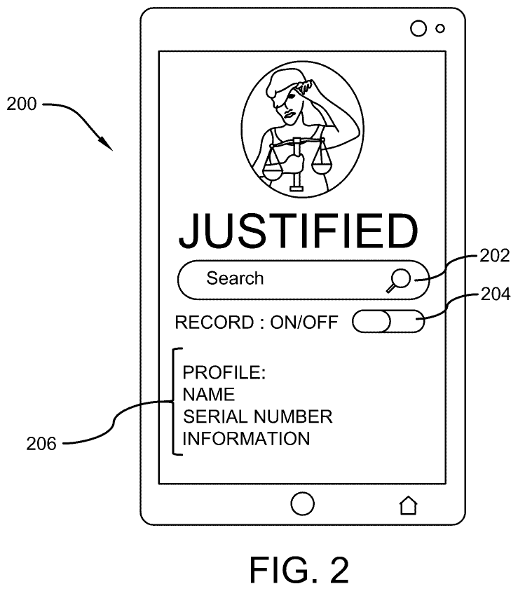

FIG. 2 illustrates an exemplary user interface displayed by the justified mobile application 100 in accordance with the disclosed structure. As illustrated, the home page 200 of the application 102 displays a search bar 202 which a user can use to search for legal information. Input can be given in the search bar 202 using voice command wherein the voice command can be locally interpreted by the application 102 and can also be processed by NLP module 110.

The home page 200 provides a recording option 204 which enables the user to record the proceedings at a police interaction. The recording may be an audio and/or video recording, which can be selected within the application 102. Legal information 206 of the logged-in user can also be displayed by the interface 200, wherein the legal information 206 may include the user's legal name, serial number, and other relevant information required for a police interrogation.

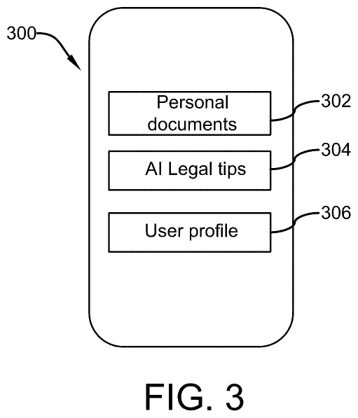

FIG. 3 illustrates an exemplary user interface for providing legal assistance to a user by the application 102 in accordance with the disclosed architecture. The user interface 300 provides a personal documents option 302 which enables a user to retrieve the personal legal documents such as but not limited to verification documents and more from the legal database 112. The personal documents can be added and can also be removed by the user based on the personal preference thereof. Further, all the personal documents are automatically verified using the regulatory authorities and can be used during the police and regulatory interrogations.

An AI legal tips option 304 provides legal tips and recommendations to the user, as generated by an AI module 114. The legal tips can be based on a topic or scenario input by the user. A user profile option 306 retrieves the personal information such as legal name, serial number, and other relevant information.

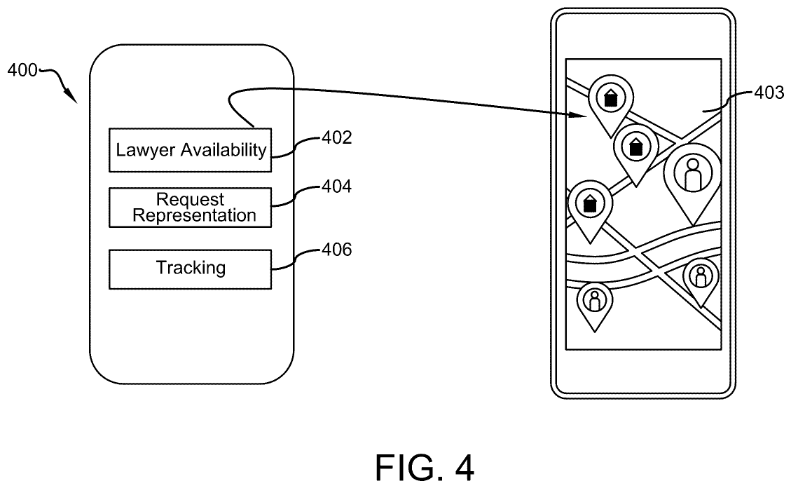

FIG. 4 illustrates another exemplary interface displayed by the legal counsel mobile application of the present invention for providing legal assistance to a user in accordance with one embodiment of the present invention. The interface 400 provides a lawyer availability option 402 which displays available lawyers in the user's area, including their proximity, contact details, and expertise. In the preferred embodiment, the option 402 when activated displays a digital map 403 which includes information of different lawyers available to help the user. One or more lawyers can be chosen by the user for assistance during a police interaction or interrogation.

A request representation option 404 enables the user to request immediate legal assistance, which could connect the user to a lawyer via phone, text, or initiate a video call. The lawyer can be pre-selected or can be a lawyer chosen by the user using the lawyer availability option 402. A tracking option 406 provides real-time status and communication with the lawyer and may show the estimated time of arrival or connection status of the lawyer, thereby keeping the user and police informed.

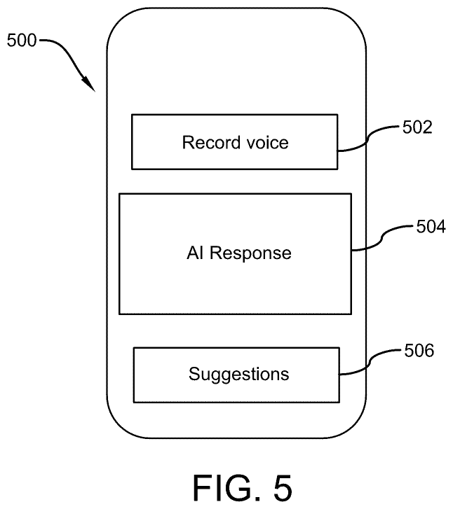

FIG. 5 illustrates a user interface displayed by the mobile application for providing AI-based legal counsel to a user in accordance with the disclosed structure. A record voice bar 502 enables a user to input voice commands and the interface 500 provides a visual representation of the user's voice as they speak, providing feedback that the application 102 is listening and processing input. The spoken input is processed by the system 100 and using the AI module 114, an AI-based legal counsel response is generated by the system 100 and is displayed on the response box 504. Along with the AI response, the interface 500 displays real-time suggestions 506 for possible commands or questions based on spoken input of the user and the suggestions can appear as text or as audio.

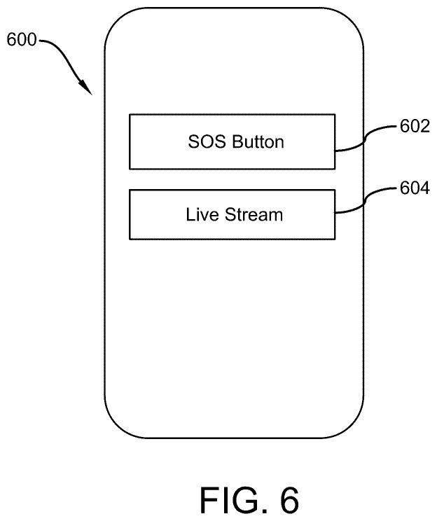

FIG. 6 illustrates a user interface for providing emergency services to a user by the system 100 in accordance with the disclosed structure. The user interface 600 displays a SOS button 602 which when pressed, sends an alert to pre-selected contacts or emergency services, along with the user's location and situation. The SOS button 602 can be pressed when the user feels threatened during a police interrogation or interaction. A livestream button 604 enables a user to start a live video stream that is sent directly to the cloud storage 122 or at least one selected contact, providing real-time evidence of the encounter. In some embodiments, the application 102 may automatically begin recording and uploading the footage to the cloud storage 122 to ensure evidence is stored even if a user's phone is compromised.

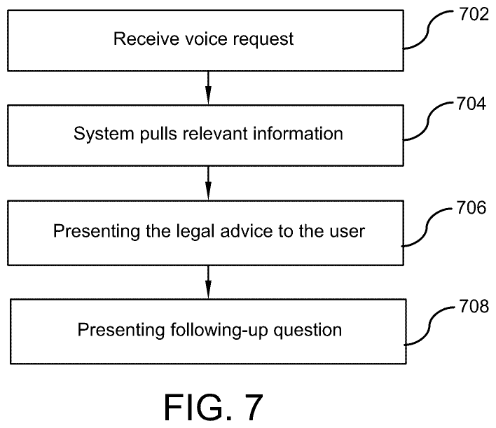

FIG. 7 illustrates a flow chart depicting a process of providing AI-based legal counsel to a user in accordance with one embodiment of the present invention. Initially, the application 102 receives a user request such as when the user speaks into the “Justified” mobile application 102 (Step 702). The input can be a command such as but not limited to “I need legal advice,” or “What are my rights in this situation?”. Once the system understands the user's request using natural language processing, the system 100 queries the legal database 112 to retrieve statutes, case law, and guidelines relevant to the situation described by the user (Step 704). The system 100 also retrieves the user's legal name or case history to provide a customized response to the user. After gathering and processing the information in the above step, the system 100 generates a customized response (Step 706). The response is designed to be clear, concise, and actionable, providing the user with the legal advice or information they need. Finally, follow-up questions are asked from the user and the questions are designed to clarify the situation further or to gather additional information that could refine the advice (Step 708).

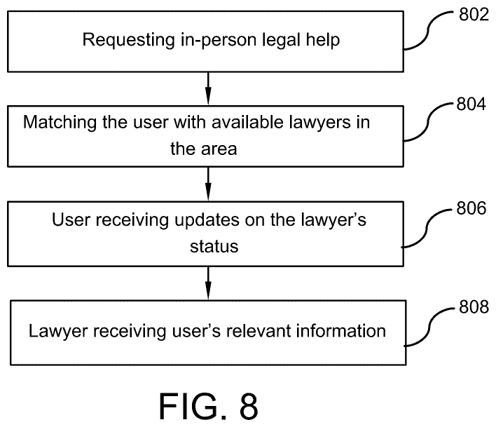

FIG. 8 illustrates another flow diagram showing a process for providing in-person legal help to a user in accordance with one embodiment of the present invention. Initially, the user initiates a request for live legal assistance through the application 102 by selecting an option or issuing a voice command (Step 802). Based on the location and profile of the user, the system locates and matches the user with nearby lawyers based on location, availability, and legal expertise (Step 804). For the selected lawyer, the application 102 provides the user with real-time updates on the lawyer's status, including estimated time of arrival or connection progress (Step 806). Also, the selected lawyer receives relevant information about the user and the situation, enabling the lawyer to provide informed legal support upon arrival or connection (Step 808).

The system 100 provides the mobile software application 102 to assist users during encounters with law enforcement. The application 102 provides legal counsel and defense in real-time through the use of artificial intelligence (AI) and also offers features to ensure the user's safety and legal rights are protected during interactions with the police. The application 102 is user-friendly, secure, and functional in various situations, from casual legal inquiries to high-stress police encounters.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein, “AI-based legal counsel application”, “mobile application”, and “application” are interchangeable and refer to the AI-based legal counsel application 102 of the present invention. Similarly, as used herein, “AI-based legal counsel system”, “legal counsel system”, and “system” are interchangeable and refer to the AI-based legal counsel system 100 of the present invention.

Notwithstanding the forgoing, the AI-based legal counsel application 102 and the AI-based legal counsel system 100 of the present invention can include any additional components to enhance the functionality and efficiency of the AI-based legal counsel application 102 and the AI-based legal counsel system 100. One of ordinary skill in the art will appreciate that the configuration and components of the AI-based legal counsel application 102 and the AI-based legal counsel system 100, as shown in the FIGS., are for illustrative purposes only, and that many other configurations and components are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An AI-based legal counsel system comprising:
a mobile application configured to communicate with a server system via a communication network;
a natural language processing module located on the server system, the natural language processing module configured to receive and process a voice command from the mobile application, converting a spoken language into an interpretable command;
a legal database stored on the server system, the legal database comprised of a repository of legal information, a statute, and a case law;
an AI module located on the server system, the AI module configured to train from a past user interaction and use the legal database to provide a real-time legal advice in response to a user request; and
a cloud storage system configured to store an encrypted user data including a legal advice, a recording of police encounters, and a personal information.

2. The AI-based legal counsel system of claim 1, wherein the mobile application is comprised of a user interface configured to allow the user to search for a legal information using a voice command or a text input.

3. The AI-based legal counsel system of claim 1, wherein the mobile application is comprised of a recording feature that records an audio or a video.

4. The AI-based legal counsel system of claim 1 further comprised of an authentication module configured to authorize a user based on an information stored in a user profile database.

5. The AI-based legal counsel system of claim 4, wherein the authentication module is further configured to manage a user subscription.

6. The AI-based legal counsel system of claim 1, wherein the AI module is configured to generate a real-time legal tip and a recommendation based on a user input.

7. The AI-based legal counsel system of claim 1, wherein the cloud storage system is configured to store an encrypted recordings of a police interaction, which is uploaded automatically to the cloud storage system when the mobile application detects a police encounter.

8. The AI-based legal counsel system of claim 1, wherein the mobile application provides a visual representation of a voice input.

9. The AI-based legal counsel system of claim 1 further comprised of a module for verifying a personal legal documents stored by the user in the legal database.

10. The AI-based legal counsel system of claim 1 further comprised of a security feature that automatically encrypts all communications between the mobile application and the server system.

11. A method of using an AI-based legal counsel system, the method comprising the following steps:
receiving a user request through a mobile application installed on an electronic computing device, wherein the request is comprised of a voice command;
processing the voice command using a natural language processing module to interpret the command;
querying a legal database stored on a server system in response to the interpreted command, the legal database comprised of a statute, a case law, and a legal guidelines;
generating a customized legal response using an AI module based on the queried legal database and a user-specific data; and
providing the customized legal response to the user through the mobile application.

12. The method of using an AI-based legal counsel system of claim 11, wherein the legal database is updated in real-time.

13. The method of using an AI-based legal counsel system of claim 11 further comprised of a step of retrieving a user-specific legal history from a user profile database.

14. The method of using an AI-based legal counsel system of claim 13 further comprised of a step of incorporating the user-specific legal history into the customized legal response.

15. A method of using an AI-based legal counsel system, the method comprising the following steps:
receiving a user request for a legal assistance via a mobile application installed on a user's electronic computing device;
locating an available lawyer based on a user's location, a legal expertise, and an availability;
matching the user with a selected lawyer and providing a real-time update on the selected lawyer's status through the mobile application; and
transmitting a relevant information about the user and a user's legal situation to the selected lawyer to enable informed legal support.

16. The method of using an AI-based legal counsel system of claim 15 further comprised of a step of displaying a map showing a proximity of the available lawyer to the user's location.

17. The method of using an AI-based legal counsel system of claim 15, wherein the real-time update is comprised of an estimated time of arrival of the selected lawyer.

18. The method of using an AI-based legal counsel system of claim 15 further comprised of a step of transmitting a video or an audio to the selected lawyer via the mobile application.

19. The method of using an AI-based legal counsel system of claim 15 further comprised of a step of initiating a communication with the selected lawyer via phone, text, or video call through the mobile application.

20. The method of using an AI-based legal counsel system of claim 15 further comprised of a step of selecting a lawyer via the mobile application based on an expertise of the lawyer.
